(19) United States
(12) Patent Application Publication
(10) Pub. No.: US 2024/0085689 A1
(43) Pub. Date: Mar. 14, 2024

(54) HYBRID MOUNT FOR OPTICAL INSTRUMENT

(71) Applicant: Nanjing iOptron Scientific, Inc. Ltd., Nanjing (CN)

(72) Inventors: Ning Xu, Nanjing (CN); Hua Jiang, Sharon, MA (US)

(21) Appl. No.: 18/466,234

(22) Filed: Sep. 13, 2023

Related U.S. Application Data
(60) Provisional application No. 63/406,032, filed on Sep. 13, 2022.

(51) Int. Cl. G02B 23/16; G01D 5/26

(52) U.S. Cl. CPC G02B 23/16; G01D 5/264; F16M 11/128

(57) ABSTRACT

A hybrid mount for an optical instrument and an associated method employs a worm gear for angular positioning about a declination axis and a harmonic gear for angular positioning about a right-ascension axis. An optical encoder measures right-ascension angles and provides a basis for correcting periodic errors introduced by the harmonic gear.

### CROSS-REFERENCE TO RELATED APPLICATIONS

This application claims the benefit of U.S. Provisional Application No. 63/406,032, filed Sep. 13, 2022, the contents and teachings of which are incorporated herein by reference in their entirety.

### BACKGROUND

Telescopes, cameras, and other optical instruments typically employ mounts for providing stable bases for observations and photography. Such mounts allow for movement of optical instruments about two orthogonal axes to facilitate pointing and tracking. For example, so-called altitude-azimuth (Alt-Az) mounts allow for up-down (altitude) and side-to-side (azimuth) movement, whereas equatorial mounts allow for movement in celestial declination (celestial latitude) and in right ascension (celestial longitude). Some mounts are adaptable and can be switched between an Alt-Az mode and an equatorial mode.

To allow for fine positioning and control, mounts for optical instruments typically provide reduction gears on their axes. The gears enable users to rotate the instruments about their axes with high precision. Many conventional mounts employ worm gears for this purpose. A worm gear includes a worm and a worm wheel. The worm is rotatable, e.g., by a motor or manual knob, and has teeth that engage corresponding teeth of the worm wheel at right angles. The worm wheel concentrically engages a shaft that forms an axis of the mount. Rotating the worm causes the worm wheel and thus the shaft to rotate. Worm-gear arrangements can achieve high gear reduction, with one complete turn of the worm rotating the worm wheel, and thus the shaft, by as little as a fraction of a degree.

Instead of using worm gears for fine positioning and control, some mounts for optical instruments instead use harmonic gears, also known as strain wave gears. A harmonic gear typically includes three components, (1) an outer circular spline with inwardly pointing teeth, (2) a middle, flexible (flex) spline with outwardly pointing teeth that can engage with teeth of the outer spline, and (3) an inner oval that has no teeth. The middle flex spline has fewer teeth than the outer spline, and the inner oval pushes diametrically opposed teeth of the middle spine so that they engage with teeth of the outer spline at only two opposing regions. As the inner oval rotates, it causes the opposing regions of teeth engagement to follow the major axis of the oval. But owing to the fact that the middle spline has fewer teeth than the outer spline, the middle spline rotates backwards, in a direction opposite that of the inner oval and by a much smaller amount. For instance, if the outer spline has 100 teeth and the middle spline has 98 teeth, then a complete rotation of the oval causes the middle spline to rotate backwards by the angular equivalent of two teeth, i.e., 7.2 degrees. Significant gear reduction can thus be achieved. In a typical arrangement, the inner oval is driven by a motor (or hand control) and the middle flex spline is coupled to the axis of the mount to be rotated.

### SUMMARY

Unfortunately, worm gears and harmonic gears both involve deficiencies. A mount that uses worm gears typically requires a counterweight when used in equatorial mode. The counterweight attaches to a declination shaft of the mount and balances a turning moment across the right-ascension axis. Without counterweights, worm gears on equatorial mounts may slip or prematurely wear. Counterweights tend to be heavy, however, and thus can impair portability. Counterweights also increase the overall size of the mounts. By contrast, harmonic gears often can be operated without counterweights and have virtually no backlash, but they typically are much costlier than worm gears. They also tend to have much larger periodic errors. As is known, “periodic errors” are positioning errors caused by inaccuracies in mechanical components of a gearing system. What is needed, therefore, is a mount that avoids at least some of the deficiencies of worm gears and at least some of the deficiencies of harmonic gears while benefiting from the respective advantages that each of them provides.

To address the above need at least in part, an improved technique provides a hybrid mount for an optical instrument. The hybrid mount employs a worm gear for angular positioning about a declination axis and a harmonic gear for angular positioning about a right-ascension axis. Advantageously, the hybrid mount can normally be operated without a counterweight, as the harmonic gear is able to safely resist the turning moment about the right-ascension axis. The hybrid mount is less costly than mounts employing two harmonic gears. It also provides low backlash on the right-ascension axis, which is typically the more critical axis when the mount is used for astrophotography.

Certain embodiments are directed to a hybrid mount for optical instruments. The hybrid mount includes a declination axle constructed and arranged to attach to an optical instrument, a declination unit having a worm gear disposed to rotate the declination axle, and a right-ascension unit having a harmonic gear disposed to rotate the declination unit about a right ascension axis. The right-ascension unit has an optical encoder configured to produce measurements of right ascension, and the measurements provide a basis for correcting a harmonic error produced by the harmonic gear.

Other embodiments are directed to a telescope that includes an optical tube assembly, a declination axle attached to the optical tube assembly, a declination unit having a worm gear disposed to rotate the declination axle, and a right-ascension unit having a harmonic gear disposed to rotate the declination unit about a right ascension axis. The right-ascension unit has an optical encoder configured to produce measurements of right ascension, said measurements providing a basis for correcting a harmonic error produced by the harmonic gear.

Still other embodiments are directed to a method of pointing a telescope mount. The method includes driving a worm of a worm gear to rotate the telescope mount in declination, driving a harmonic gear to rotate the telescope mount in right ascension, and correcting periodic errors in right ascension using an optical encoder.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a perspective view of an example hybrid mount according to embodiments of the improved technique, in which no counterweight is provided.

FIG. 2 is a perspective view of an example hybrid mount according to embodiments of the improved technique, in which a counterweight is provided.

FIG. 3 is a schematic view of an example harmonic gear configured to drive a right-ascension axis of the hybrid mount of FIG. 1 and/or FIG. 2.

FIG. 4 is a block diagram of an example electronic system of the hybrid mount of FIG. 1 and/or FIG. 2.

FIG. 5 is a block diagram of an example feedback loop in which periodic errors of the harmonic gear of FIG. 3 are reduced or eliminated.

FIGS. 6a-6c are schematic views of respective non-limiting implementations of an example electronic brake for the right-ascension axis of the hybrid mount of FIG. 1 and/or FIG. 2.

FIG. 7 is a flowchart of an example method of pointing a hybrid mount, such as the one shown in FIG. 1 and/or FIG. 2.

### DETAILED DESCRIPTION

Embodiments of the improved technique will now be described. One should appreciate that such embodiments are provided by way of example to illustrate certain features and principles but are not intended to be limiting.

An improved technique provides a hybrid mount for an optical instrument. The hybrid mount employs a worm gear for angular positioning about a declination axis and a harmonic gear for angular positioning about a right-ascension axis. Advantageously, the hybrid mount can normally be operated without a counterweight, as the harmonic gear is able to safely resist the turning moment about the right-ascension axis. The hybrid mount is less costly than mounts employing two harmonic gears. It also provides low backlash on the right-ascension axis, which is typically the more critical axis when the mount is used for astrophotography.

Although the harmonic gear can make the hybrid mount susceptible to periodic error, some examples reduce or eliminate periodic error by providing a high-precision optical encoder on the right-ascension axis. For example, the high-precision optical encoder precisely measures the angle of the right-ascension axis and allows corrections to be made in software. In some examples, a control signal establishes a desired angle of the right-ascension axis and a motor drives the harmonic gear under feedback control, so that the angle measured by the precision optical encoder is made to precisely match the desired angle. Periodic errors in the harmonic gear are thereby rendered irrelevant under closed-loop operation.

In some examples, the motor that drives the right-ascension axis is a stepper motor, and the stepper motor drives the right-ascension axis via the harmonic gear. For example, the stepper motor has a shaft coupled to an oval spline of the harmonic gear, and a middle flex spline of the harmonic gear provides right-ascension rotation. The shaft of the stepper motor rotates in precise angular increments in response to input signals from a drive circuit.

In some examples, the stepper motor includes at least a first coil and a second coil, with each coil having two terminals by which the respective coil is driven by the drive circuit.

In some examples, an electronic brake is provided for the right-ascension axis by a switch that connects together the terminals of one of the coils of the stepper motor. For example, short-circuiting a coil of the stepper motor via a switch has the effect of increasing the resistance to rotation of the shaft of the stepper motor in response to externally-applied torque, thereby increasing the applied torque required to rotate the optical instrument in right-ascension. One switch may be provided for a single coil of the stepper motor, or multiple switches may be provided for respective coils. The switch or switches thus act as an electronically controllable brake, which may avoid the need for any mechanical brake on the right-ascension axis.

In some examples, resistance of the brake is established or varied by short-circuiting different numbers of coils. For example, a lower level of resistance may be established by short-circuiting the terminals of a single coil, and a higher level of resistance may be established by short-circuiting the respective terminals of two coils.

In some examples, a resistor is provided between the terminals of a coil, or a respective resistor is provided between the terminals of each of multiple respective coils) to establish a desired level of braking torque, i.e., torque required of an external force to rotate the hybrid mount in right-ascension. According to some examples, multiple resistors may be provided for the coil (or for each of multiple coils), and the resistors may be selectable to vary the desired torque. In some examples, a variable-resistance potentiometer may be used in place of multiple resistors for each coil. For example, a lower-resistance (higher-torque) setting may be used for heavier optical instruments, and a higher-resistance (lower-torque) setting may be used for lighter optical instruments. In some examples, a resistor is used in place of a switch, e.g., by being connected directly to the terminals of a coil. In other examples, a resistor is used along with a switch, e.g., in series with the switch.

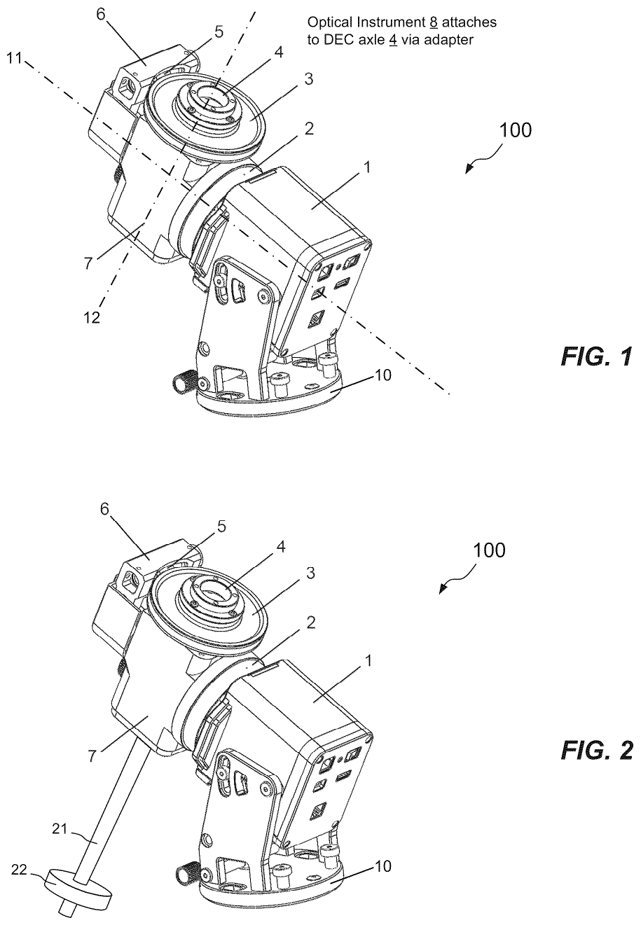

FIG. 1 shows an example hybrid mount 100 according to an embodiment of the disclosure. As shown, hybrid mount 100 includes a right-ascension (RA) unit 1 attached to a base 10. The base 10 may be attached to a tripod or pier (not shown), for example. The RA unit 1 has a fixed position relative to the base 10 but may be adjustable in altitude (pitch) relative to the base 10 for accommodating different geographic latitudes. The hybrid mount 100 further includes a declination (DEC) unit 7, which includes a DEC axle 4 configured to rotate in declination within the DEC unit 7. The DEC unit 7 itself is configured to rotate in right ascension relative to the RA unit 1. The DEC axle 4 is configured to connect, via an adapter (not shown) to an optical instrument 8, such as a telescope optical assembly or a camera (not shown). The adapter may be provided as a dovetail or cradle, for example. Together, the RA unit 1 and DEC unit 7 support rotation about two orthogonal axes, right ascension 11 and declination 12, and thus enable the optical instrument 8 to be pointed to any celestial coordinates above the horizon in the sky.

The RA unit 1 includes components that are constructed and arranged to rotate the DEC unit 7 in right ascension 11. In accordance with improvements hereof, the components include a harmonic gear, also known as a strain wave gear. The harmonic gear includes an outer spline fixedly attached to the RA unit 1, a middle flex spline 2 fixedly attached to the DEC unit 7, and an inner oval spline driven by an RA motor. As the RA motor turns, the harmonic gear rotates the DEC unit 7 relative to the RA unit 1 and achieves substantial gear reduction. In some examples, the RA unit 1 also houses a power supply, electronic connectors, and various control circuitry for electronically controlling the hybrid mount 100, such as a microprocessor or microcontroller, electronic memory, communications circuitry, motor-drive circuitry, and the like. In other examples, at least some of the connectors and/or control circuitry is housed within the DEC unit 7 or is distributed between the RA unit 1 and the DEC unit 7. Connectors and control circuitry may also be housed within the base 10. In addition, some embodiments may employ a separate hand controller (not shown) for facilitating user control of the hybrid mount 100.

As further shown in FIG. 1, the DEC unit 7 includes a worm gear assembly 6, which is composed of a worm 5 and a worm wheel 3. The worm wheel 3 (also called a “ring gear”) is fixedly attached to the DEC axle 4, such that the worm wheel 3 and DEC axle 4 rotate within the DEC unit 7 together as one. The worm 5 includes teeth, which engage with opposing teeth in the worm wheel 3, such that rotation of the worm 5 within the assembly 6 effects corresponding but reduced rotation of the worm wheel 3. The worm wheel 3 may be driven by a DEC motor within the DEC unit 7. To provide measures of angular position, the RA unit 1 and DEC unit 7 may each include a respective optical encoder.

Advantageously, the hybrid mount 100 may be used in many instances without a counterweight. As shown in FIG. 2, a counterweight 22 would normally be placed opposite the optical instrument 8 on a shaft 21 that is colinear with the DEC axle 4. Although a counterweight 22 may optionally be used with the hybrid mount 100, if desired, the mount 100 does not itself require a counterweight 22, as the harmonic gear is able to withstand the turning moment induced by the weight of the optical instrument 8 without slip or excessive wear. It is noted that balance in declination is usually achieved merely by moving the optical instrument forward or back within the above-described adapter, e.g., dovetail or cradle.

The hybrid mount 100 as depicted is configured in equatorial mode, in which the mount, once polar aligned, can track celestial objects by rotating primarily in right-ascension only (i.e., one revolution per day). The same hybrid mount 100 can also be configured in Alt-Az mode, however. For example, the mount may be oriented vertically on the base 10. In this mode, altitude adjustments may be achieved via the DEC unit 7 and azimuth adjustments may be achieved via the RA unit 1. Thus, embodiments are not limited to equatorial applications.

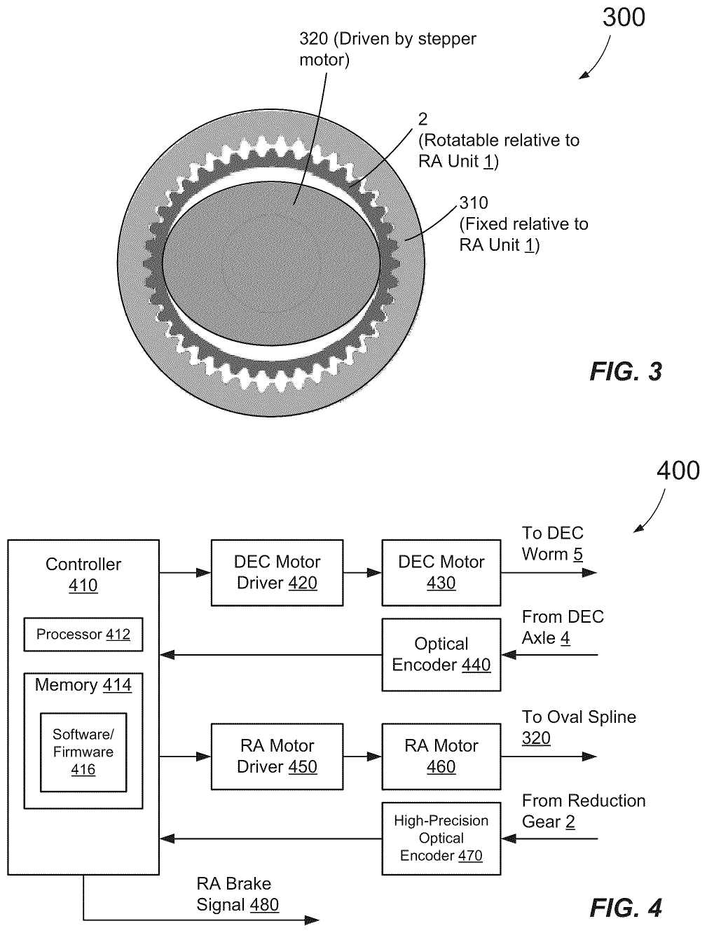

FIG. 3 shows an example harmonic gear 300, which is suitable for use within the RA unit 1. As shown, the harmonic gear 300 includes an outer spline 310, which is rotationally fixed relative to the RA unit 1. For example, the outer spline 310 may be screwed or otherwise attached to a wall of the RA unit 1, such as the wall facing the DEC unit 7.

The harmonic gear 300 further includes an inner (oval) spline 320, which may be coupled to the RA motor. For example, the inner spline 320 may be connected directly to a shaft of the RA motor, such that rotating the shaft also rotates the inner spline 320. In some examples, additional gears (not shown) may be provided between the shaft of the RA motor and the inner spline 320, for achieving additional gear reduction.

The harmonic gear 300 still further includes a middle (flex) spline 2, which is also depicted in FIGS. 1 and 2. The middle flex spline 2 is rigid yet deformable, such that, as the inner spline 320 rotates, opposing regions of contact between the middle spline 2 and the outer spline 310 rotate along with the inner spline 320. Gear reduction is achieved because the middle spline 2 has fewer teeth than the outer spline 310, causing the middle spline 2 (which is coupled to the DEC unit 7) to rotate backwards relative to the inner spline 320 and by a fraction of the amount. One should appreciate that the harmonic gear 300 has virtually no backlash and thus is well-suited for supporting fine adjustments in alternating directions.

FIG. 4 shows an example of certain electronic and electromechanical components of the hybrid mount 100. As shown, a controller 410, such as a microcontroller or microprocessor, includes a processor 412 (e.g., a central processing unit) and memory 414. The memory 414 stores software and/or firmware configured to operate the hybrid mount 100, e.g., in response to user control, which may involve the use of a separate handheld controller. The controller 420 controls a DEC motor driver 420 for driving a DEC motor 430, as well as an RA motor driver 450 for driving an RA motor 460. The DEC motor driver 420 and the RA motor driver 450 each include circuitry for driving the respective motors. The DEC motor 430 has a shaft (not shown) that drives the worm 5 of the worm assembly 6 (FIGS. 1 and 2), and the RA motor 460 has a shaft (not shown) that drives the inner (oval) spline 320 of the harmonic gear 300.

Preferably, the RA motor 460 is a stepper motor. As is known, stepper motors provide precise control over the angle of a motor shaft in fine increments. For the same reason, the DEC motor 430 may also be a stepper motor, although the DEC motor 430 alternatively may be implemented using a DC servo motor.

As further shown in FIG. 4, the components also include an optical encoder 440, which generates measurements of declination angle and provides the measurements to the controller 410. For example, the optical encoder 440 has a first part coupled to a body of the DEC unit 7 and a second part coupled to and coaxial with the DEC axle 4.

The components still further include an optical encoder 470 for measuring right ascension angle. For example, the optical encoder 470 has a first part coupled to a body of the RA unit 1 and a second part coupled to and coaxial with the middle (flex) spline 2 of the harmonic gear 300.

In accordance with further improvements hereof, the optical encoder 470 is preferably a high-precision optical encoder, i.e., an encoder with an angular resolution of no greater than 0.1 arc-seconds and preferably no greater than 0.02 arc-seconds. As explained more fully below, the high-precision optical encoder 470 enables the hybrid mount 100 to correct for large periodic errors, which may be inherent in the harmonic gear 300. Although the encoder 440 in the DEC unit 7 may also be high-precision, this is not required and typically is not justified based on cost or performance. Thus, the optical encoder 440 is preferably a standard encoder.

In some examples, as still further shown in FIG. 4, the controller 410 may generate a right-ascension brake signal 480. As described further below, the brake signal 480 controls an electronic brake for the RA unit 1.

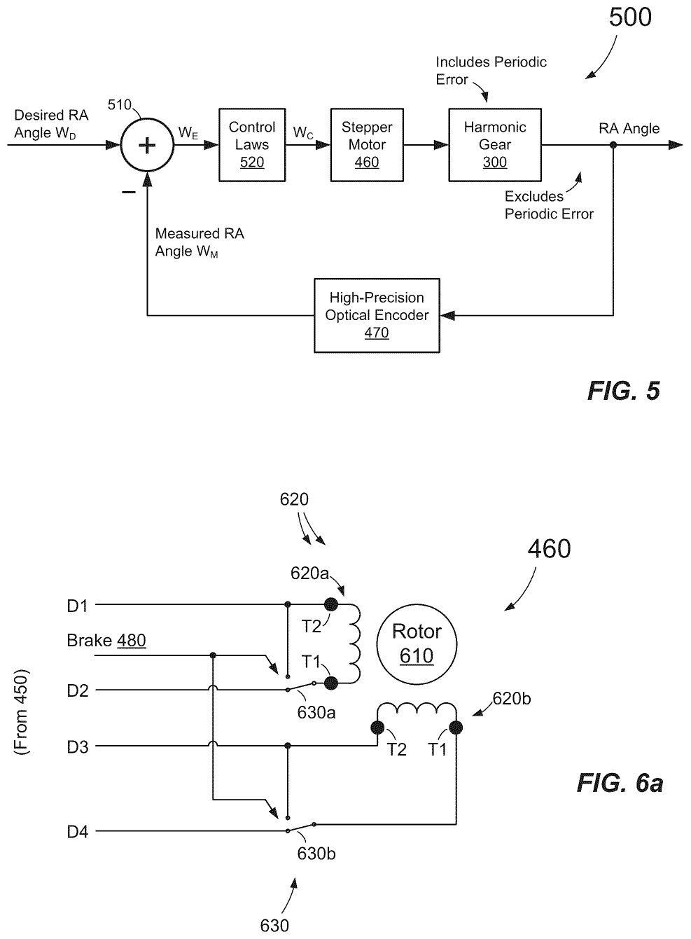

FIG. 5 shows an example control loop 500 for controlling right-ascension in the hybrid mount 100. The control loop 500 may be realized, for example, using certain of the components shown in FIG. 4. In addition, certain of the elements of the control loop 500 may be implemented using software and/or firmware 416 running in the memory 414 of the controller 410. One should appreciate that the depicted control loop 500 is merely an example intended to illustrate principles of operation and is not intended to be limiting.

As shown in FIG. 5, the control loop 500 has a forward path that includes a summer 510, control laws 520, the above-described RA motor 460 (a stepper motor), and the above-described harmonic gear 300. The control loop 500 also includes the high-precision optical encoder 470 in a feedback path. The encoder 470 is configured to measure the actual right-ascension angle (RA angle) of the hybrid mount 100.

In example operation, the control loop 500 receives a control signal that indicates a desired right-ascension angle W_{D}, and the encoder 470 generates a measured right-ascension angle W_{M}. The desired right-ascension angle W_{D} is a prescribed value, typically provided by the controller 410.

Summer 510 receives both W_{D} and W_{M} and generates a difference between the two, W_{E}, which represents an error signal. Control laws 520 process W_{E} to generate a control value, W_{C}, e.g., by applying multiplication, integration, and/or differentiation for establishing desired dynamic performance and closed-loop stability. The control value W_{C} then drives the stepper motor 460. Note that the RA motor driver 450 is assumed to be present but is omitted from FIG. 5 for simplicity. The stepper motor 460 responds to W_{C} by driving the harmonic gear 300, i.e., the inner oval spline 320. Rotating the inner spline 320 causes the middle flex spline 2 to rotate, causing the hybrid mount 100 to turn in right ascension. Closed-loop operation of the control loop 500 tends to drive the output (RA angle) so that the measured right-ascension angle W_{M} precisely matches the desired right-ascension angle W_{D}.

The depicted arrangement reduces to zero or near zero any periodic error introduced by the harmonic gear 300. Because feedback ensures that W_{M} precisely matches W_{D}, any errors introduced by the harmonic gear 300 have negligible effect on the output RA angle. The main source of error in control loop 500 is rather the encoder 470, but the encoder 470 is precise by design.

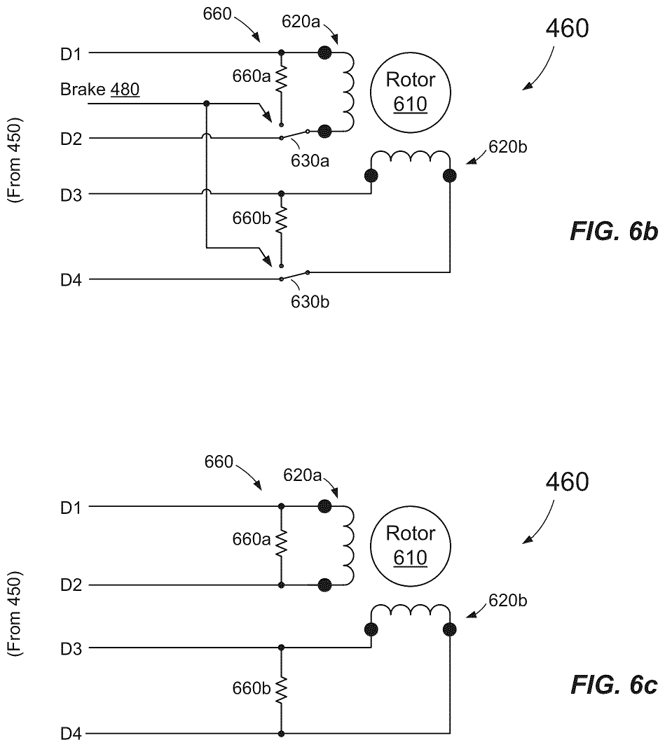

FIGS. 6a through 6c show various examples of an electronic right-ascension brake, which may be used in the hybrid mount 100. Given that the hybrid mount 100 can operate without a counterweight, some form of brake would be desirable for preventing the mount from slumping down and potentially damaging expensive optical equipment when power is turned off. A mechanical friction brake is normally used for this purpose, but mechanical brakes include multiple components and add cost, weight, and complexity.

Rather than relying on a mechanical brake, we have recognized that the stepper motor 460 itself may be used as a type of brake. More specifically, a typical stepper motor includes at least two coils for controlling its shaft rotation. Normally, motor drive circuits energize the coils to induce a desired degree and direction of rotation. Stepper motors can also act as generators, however, when their shafts are subjected to externally-applied rotation. In this generator mode, the torque required to turn the shaft increases markedly when at least one of the coils is short-circuited. Thus, by short-circuiting one or more coils of the stepper motor 460, the shaft of the stepper motor 460 is made to resist rotation and thus acts as a type of brake. When such resistance is combined with gear multiplication (caused by back-driving the reducing harmonic gear), a large resisting torque can be created, such that significant torque is required to rotate the hybrid mount 100 in right ascension. Such resisting torque is preferably larger than the torque induced by the optical instrument 8 held by the hybrid mount 100 without a counterweight, such that the hybrid mount 100 does not slump down under the weight of the optical instrument 8.

FIG. 6a shows one example arrangement of an electronic brake. Here, stepper motor 460 is seen to have a rotor 610 and coils 620, such as two coils 620a and 620b. The stepper motor 460 may include additional coils, and the coils may be provided as unipolar or bipolar coils. The coils 620 may be driven by drive signals D1, D2, D3, and D4 generated by the RA motor driver 450 (FIG. 4). For example, RA motor driver 450 varies the signals D1-D4 in predetermined patterns to establish the desired degrees and directions of rotation, e.g., as specified by controller 410.

To realize an electronic brake, the above-described RA brake signal 480 controls a pair of Form-C (single pole, double throw) switches 630. The switches 630 may be realized as relays, solid-state switches, discrete transistor switches, or switches of any other type. Each of the switches 630 (e.g., 630a or 630b) has a pole that connects to a first terminal T1 of a respective coil, a first contact that receives a drive signal (D2 or D4), and a second contact that connects (e.g., via a wire or circuitboard trace) to a second terminal T2 of the respective coil. When the switches 630 are in the Down position (as shown), all of the drive signals D1-D4 reach the coils 630 and operation of the stepper motor 460 is normal. But when the switches 630 are in the Up position, the drive signals can no longer form complete circuits and the coils 630 are short-circuited. As indicated above, short-circuiting the coils 630 turns the stepper motor 460 into a type of brake. Thus, electronic braking may be realized by controlling switches 630 using brake signal 480.

Although two switches 630a and 630b are shown, some embodiments may use only a single switch. A single switch may be preferred, for example, in cases in which short-circuiting a single coil 630 is sufficient for establishing the desired braking torque. Also, greater than two switches 630 may be used, as desired, in stepper motors that have greater than two coils. In some examples, a switch 630 is provided on each coil of the stepper motor 460, and the switches may be independently controlled, such that more switches may be used when higher braking torque is desired and fewer switches may be used when lower braking torque is desired.

Preferably, the switches 630 have a normally-closed position, which is the Up position in which the coils 630 of the respective switches are short-circuited. In this manner, the electronic brake engages automatically when power is turned off, protecting the optical instrument from damage. It is noted that no external source of power is needed for operating the electronic brake.

FIG. 6b shows another example implementation of an electronic brake. The FIG. 6b arrangement is similar to the one shown in FIG. 6a, except that a resistor 660 (660a or 660b) is placed in each short-circuit path. Resistors 660 result in reduced braking torque than direct short circuits and thus provide a mechanism for tuning the braking torque to meet user requirements. For example, smaller-resistance resistors 660 tend to produce higher braking torque, whereas larger-resistance resistors 660 tend to produce lower braking torque.

In some examples, resistors 660 may be provided as variable-resistance elements, such as potentiometers, which allow resistance to be varied (e.g., via a knob or set screw). In other examples, banks of resistors may be provided, in place of individual resistors, in which one of multiple resistors may be selected at a time for achieving a desired braking torque. Any number of switches 630 and resistors 660 may be provided, e.g., for only one coil or for each of multiple coils.

FIG. 6c shows yet another example of an electronic brake. Here, resistors 660 are provided but there are no switches 630. Also, the RA brake signal 480 is not needed. The FIG. 6c arrangement requires fewer parts than do the others, but it has dependencies that the other solutions do not. For example, the FIG. 6c arrangement requires that the drive signals D1-D4 have sufficient current capacity to drive the resistors 660 in parallel with the coils 620. It also requires the RA motor driver 450 to withstand voltage transients that may result from the stepper motor 460 acting as a generator in response to externally applied forces. These dependencies may be easily satisfied in some embodiments, however.

Although not shown, still another implementation of an electronic brake may be realized within the RA motor driver 450 itself. For example, the RA motor driver 450 may be configured automatically to short circuit D1 to D2 and to short-circuit D3 to D4 when power is turned off or in response to a brake command 480. Such an arrangement would avoid the need for any additional parts.

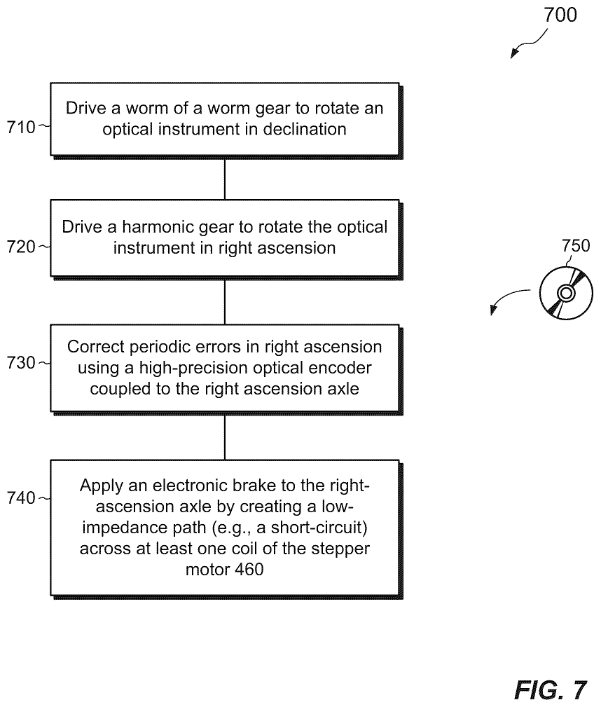

FIG. 7 shows an example method 700 that may be carried out in connection with the hybrid mount 100. The method 700 may be performed, for example, under direction of the controller 410 running the software and/or firmware 416. The various acts of method 700 may be ordered in any suitable way, which may include performing some acts simultaneously.

At 710, the controller 410 drives a worm 5 of a worm gear 6 to rotate the optical instrument 8 in declination. At 720, the controller 410 drives a harmonic gear 300 to rotate the optical instrument 8 in right ascension. At 730, the controller 410 corrects periodic errors in right ascension, e.g., those introduced by the harmonic gear 300, using a high-precision optical encoder coupled to the right ascension axle. At 740, the controller 410 applies an electronic brake to the right-ascension axle by creating a low-impedance path (e.g., a short-circuit or resistor) across at least one coil of the stepper motor 460.

An improved technique has been described which provides a hybrid mount for an optical instrument. The hybrid mount employs a worm gear for angular positioning about a declination axis and a harmonic gear for angular positioning about a right-ascension axis. Advantageously, the hybrid mount can normally be operated without a counterweight, as the harmonic gear is safely able to resist the turning moment about the right-ascension axis. The hybrid mount is less costly than mounts employing two harmonic gears. It also provides low backlash on the right-ascension axis, which is typically the more critical axis when the mount is used for astrophotography.

Having described certain embodiments, numerous alternative embodiments or variations can be made. For example, although the hybrid mount 100 is shown as having a particular design (similar to a German equatorial mount), embodiments are not limited to German equatorial mounts or their variants. Rather, embodiments may be used with other types of equatorial mounts or with Alt-Az mounts.

Also, although the electronic brake has been described in connection with a hybrid mount that includes a worm gear for declination and a harmonic gear for right-ascension, the electronic brake may also be used in mounts that use harmonic gears on both axes. In such embodiments, an electronic brake like any of the ones described above may also be used on the declination axis.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 750 in FIG. 7). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the disclosure.

What is claimed is:

1. A hybrid mount for optical instruments, comprising:
a declination axle constructed and arranged to attach to an optical instrument;
a declination unit having a worm gear disposed to rotate the declination axle; and
a right-ascension unit having a harmonic gear disposed to rotate the declination unit about a right ascension axis, the right-ascension unit having an optical encoder configured to produce measurements of right ascension, said measurements providing a basis for correcting a harmonic error produced by the harmonic gear.

2. The hybrid mount of claim 1, wherein the harmonic gear is constructed and arranged to resist turning moments, such that the hybrid mount does not include a declination-axis counterweight.

3. The hybrid mount of claim 1, wherein the optical encoder has an angular error of less than 0.02 arc-seconds.

4. The hybrid mount of claim 1, wherein the optical encoder has an angular error of less than 0.1 arc-seconds.

5. The hybrid mount of claim 4, further comprising control circuitry having an input that represents a desired right-ascension angle, the control circuitry constructed and arranged to rotate the declination unit in right ascension under closed-loop feedback control, such that the measurements of right ascension substantially match the desired right-ascension angle.

6. The hybrid mount of claim 1, wherein the right-ascension unit includes a stepper motor coupled to the harmonic gear for rotating the declination unit in right ascension.

7. The hybrid mount of claim 6, further comprising:
drive circuitry coupled to first and second coils of the stepper motor for driving a shaft of the stepper motor forward and backwards; and
a switch coupled across terminals of the first coil for selectively short-circuiting the first coil, causing the stepper motor to act as a brake that resists right-ascension rotation in response to applied forces.

8. The hybrid mount of claim 7, wherein the stepper motor acts as a brake without requiring power, and wherein the hybrid mount does not include a mechanical right-ascension brake.

9. The hybrid mount of claim 7, further comprising a second switch coupled across terminals of the second coil for selectively short-circuiting the second coil and increasing an applied force that the brake can resist beyond that which is achieved by short-circuiting the first coil only.

10. The hybrid mount of claim 7, further comprising a resistor connected in series with the switch, the resistor having a resistance value selected to provide a desired resistance to right-ascension rotation in response to applied forces.

11. A telescope, comprising:
an optical tube assembly;
a declination axle attached to the optical tube assembly;
a declination unit having a worm gear disposed to rotate the declination axle; and
a right-ascension unit having a harmonic gear disposed to rotate the declination unit about a right ascension axis, the right-ascension unit having an optical encoder configured to produce measurements of right ascension, said measurements providing a basis for correcting a harmonic error produced by the harmonic gear.

12. The telescope of claim 11, wherein the harmonic gear is constructed and arranged to resist turning moments, such that the telescope does not include a declination-axis counterweight.

13. The telescope of claim 11, further comprising control circuitry having an input that represents a desired right-ascension angle, the control circuitry constructed and arranged to rotate the declination unit in right ascension under closed-loop feedback control, such that the measurements of right ascension substantially match the desired right-ascension angle.

14. A method of pointing a telescope mount, comprising:
driving a worm of a worm gear to rotate the telescope mount in declination;
driving a harmonic gear to rotate the telescope mount in right ascension; and;
correcting periodic errors in right ascension using an optical encoder.

15. The method of claim 14, wherein correcting the periodic errors includes applying closed-loop feedback control to substantially match measurements of right-ascension made using the optical encoder with desired right-ascension angles.

16. The method of claim 14, wherein driving the harmonic gear includes controlling a stepper motor to rotate a spline of the harmonic gear.

17. The method of claim 16, further comprising applying an electronic right-ascension brake to the telescope mount by short-circuiting one or more input coils of the stepper motor.

18. The method of claim 17, wherein short-circuiting said one or more input coils of the stepper motor includes:
short-circuiting a first input coil of the stepper motor for achieving a first resistance to applied forces; and
short-circuiting both the first input coil and a second input coil of the stepper motor for achieving a second resistance to applied forces, the second resistance being greater than the first resistance.

19. The method of claim 17, wherein short-circuiting said one or more input coils of the stepper motor includes connecting together first and second terminals of at least one of the input coils through a resistor.

20. The method of claim 17, wherein the telescope mount is operated without a declination-axle counterweight.
